(19) United States
(12) Patent Application Publication
(10) Pub. No.: US 2009/0248576 A1
(43) Pub. Date: Oct. 1, 2009

(54) VARIABLE RATES FOR THIRD PARTY BILL PAYMENT OVER NET (TPBP) AND OTHER SERVICES

(75) Inventors: Basavaraj Patil, Cypress, CA (US); Michael A. Peguero, Cypress, CA (US); Nagaraja Ramappa, Cypress, CA (US)

Correspondence Address: PEARNE & GORDON LLP, 1801 EAST 9TH STREET, SUITE 1200, CLEVELAND, OH, 44114-3108, US

(73) Assignee: OPERSOFT LLC, Cypress, CA (US)

(21) Appl. No.: 12/054,683

(22) Filed: Mar. 25, 2008

(51) Int. Cl. G06Q 40/00

(52) U.S. Cl. 705/40

(57) ABSTRACT

An online system which integrates the business components of Shipping, Freight Forwarding and making available Banking credit by means of an effective bidding system on Service Charges and Interest Rates for each bill payment. The System is an advancement over the existing Banking credit line systems and enhances the business process by providing optimum usage of Banking resources at the customers end as well as providing optimum lending opportunities to customers from the Banking end.

### FIELD OF THE INVENTION

The Present invention relates to banking application in the B2B marketplace, More particularly, where the application gives an option to the Banking customers' to get online quotes on the service charges and the interest rates that he will be charged by the banks that have extended him a line of credit towards bill payments.

### BACKGROUND AND PRIOR ART

The invention is an improvement over existing systems of software operating systems that are custom developed for a particular individual or Company engaged in business, more particularly in the field of Shipping, freight forwarders and payment by Banks or Financial Institutions.

The present invention relates to a open marketplace ecosystem wherein the consumer and the service provider is engaged in the process of maximum utilisation of resources available with them, thereby maximising the returns on business in terms of profit and operational costs.

The present invention is also advancement over static business systems where the options available to the consumer and the business provider are limited to a linear access and not a multiple choice provider as seen in this invention.

The present invention is also providing for a facility of Variable Rates for Third Party Bill Payment over the Internet is unique in its concept of application over any of the prevailing methods.

### SUMMARY OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

Here the Banking customer has an option to choose the bank to provide him a particular type of service (Bill Payment). The entire process works on the Internet and works along the following steps (a) Financial Bank logs on to the Internet based Company portal and opens an account (b) Financial Bank enters its profile and also chooses the lending range it wants to offer. (c) Banking customer logs on to the Internet based Company portal and opens an account. (d) Banking customer searches for banks on the Internet based Company portal and will request online for Limit (credit lines) approvals. Banks that approve his Limits (credit lines) will be the players in his marketplace. (e) Banking customer will enter the details of the bills that needs to be paid to vendor on the Internet based Company portal and will request his approved banks to bid on the service charges and interest rates for the bill payment by Third Party Bill Payment over the Internet. (f) Banking customer decides which bank needs to pay his bill to the vendor. (g) The entire process of this bidding for the Third Party Bill Payment is done over the net.

At present, the Bill Payments by banks is a very common Instrument used by Banking Customers. In the present invention the Bill payment is done on mutually agreed fixed charges and at approved interest rates. The relationship between Banking Customer and Bank is one to one.

### OBJECTS OF THE PRESENT INVENTION

An Object of this invention is to use the relationship is of one customer having a choice of many Banks' offering variable service charges and interest rates. The advantage of the same is that the Banks can no longer charge a fixed service charges and interest rate. Service charges and Interest rates depend on the market conditions, their cash reserves, customer rating, returns expected and many other market dynamics and variables.

### ADVANTAGES OVER PRIOR ART

The advantages of the current invention are that the Banks are looking for new banking Instruments they can use over Internet to disburse money and make some higher returns. Third party bill payment over net will be one such new Banking Instrument that will revolutionize the way commercial banking is done. Banks who evaluate process on the basis of timely exchange of money will be able to disburse the funds over the net on short term basis and make some higher return instead of leading the same on “Interbank Lending Rate”. Third party bill payment over net will be an Internet based Banking Instrument, thus servicing Third Party Bill Payment will cost less than a regular Bill payment in traditional manner.

The Work Flow of the invention functions under the following conditions and there are multiple inputs that require the ‘Third Party Bill Payment system to function in an organised manner. The inputs required for the same are illustrated below:
a) Parties involved—Shippers, Freight Forwarders and Bankers
b) Shippers: Anyone who has got freight to ship. Shipper can be a retailer, wholesaler, agent, manufacturer or a freight forwarder who wants to ship via other carriers.
c) Freight Forwarder—Freight Forwarder is a carrier or his agent who will ship the freight via ground, air or sea. This can be domestic or international. It can be consolidation service, regular service or courier.
d) Banker—Any institution that is allowed to carry on with banking functions

The flow of information and the process is as illustrated as below;
a) Shipper, Freight Forwarder and Banker will Log on to the Company's Internet portal and will register
b) Shipper logs on to the portal and enters the freight details illustrated in FIG. 4
c) Freight Forwarder logs on to the portal with an intention of filling the vessel to reduce the perishable space illustrated in FIG. 5.
d) Shipper would have received multiple quotes and he'll accept one that best suites him. Shipper is able to ship his freight at the best available market rates illustrated in FIG. 6.
e) Freight forwarder will ship the freight on his quote being accepted. This is end of Logistics Process.
f) If Freight forwarder wants to collect the payment in advance and if the shipper has a policy of paying after certain days then the shipper will opt for Third Party Bill Payment over the net.
g) Shipper will log on to Company's Internet portal and will search for banks that are ready to lend him Limits (Line of credit). He'll fill in online application and will provide them necessary documents to take decision to lend him Limits or not illustrated in FIGS. 7 and 8.
h) Shipper may or may not accept the Limits offered by the Bank. This is the end of “Limit Approval Process” illustrated in FIG. 9.
i) Shipper puts the freight invoice (it can be any vendor invoice) on to the portal for his banks to bid on the payment terms (interest and service charges) illustrated in FIG. 10.
j) Banks will quote to provide this service (paying bills to the vendor or in this case freight forwarder) illustrated in FIG. 11.
k) Shipper will accept the best quote that satisfies his situation illustrated in FIG. 12.
l) Shipper is able to make payment to the freight forwarder on freight forwarders terms via TPBP; Third Party is the Bank in this case. Banker is able to disburse money online and make decent returns on his investment—illustrated in FIGS. 13 and 14.

### BRIEF DESCRIPTION OF THE DRAWINGS

The Figures illustrating the process flow are as mentioned below

FIG. 1—Shipper Registration;

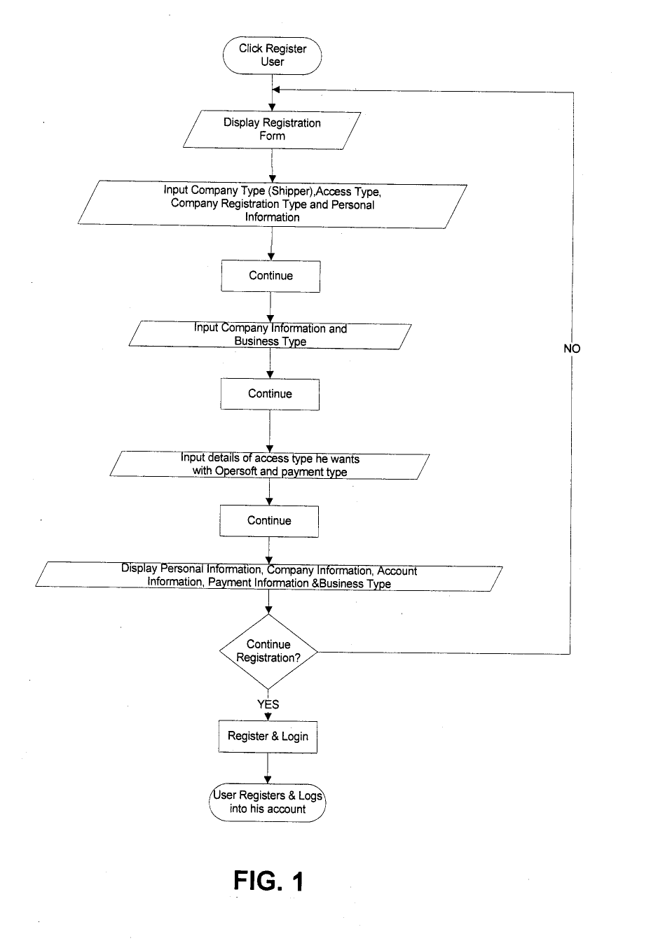

FIG. 2—Freight Forwarder Registration;

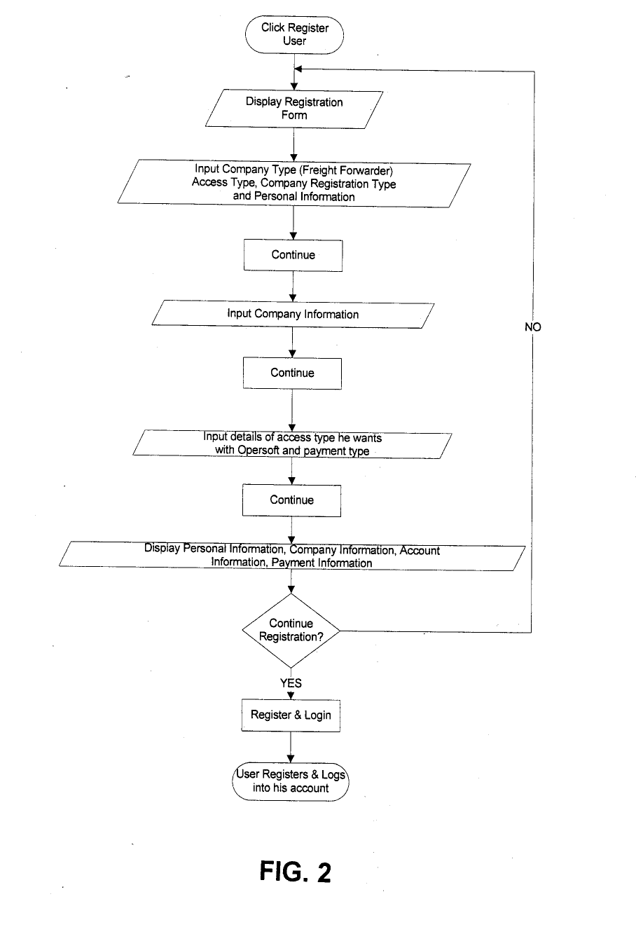

FIG. 3—Banker Registration;

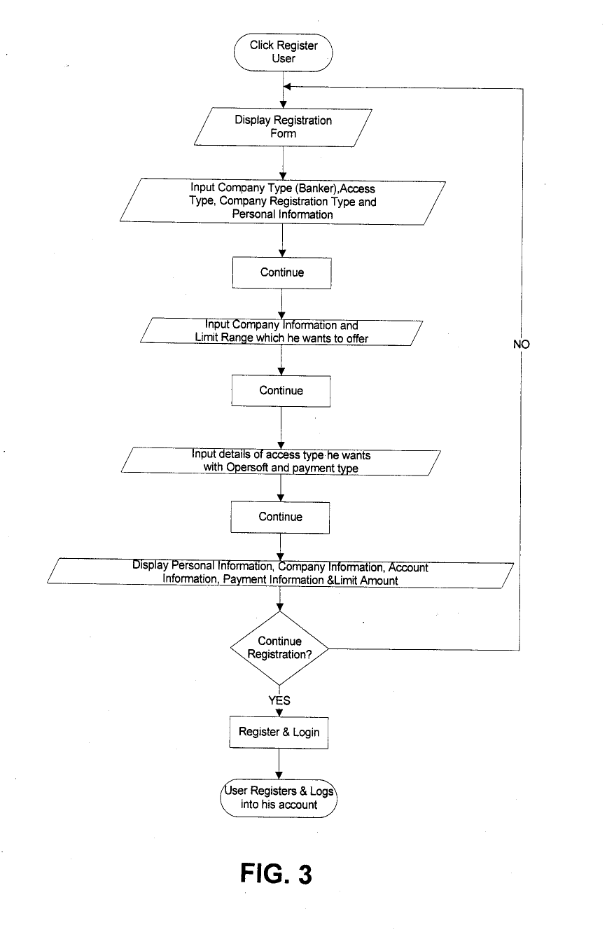

FIG. 4—Quote Request by Shipper;

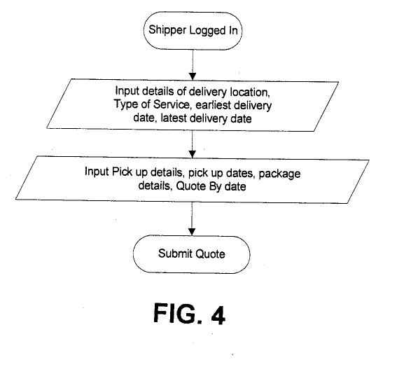

FIG. 5—Freight Quote by Freight Forwarder;

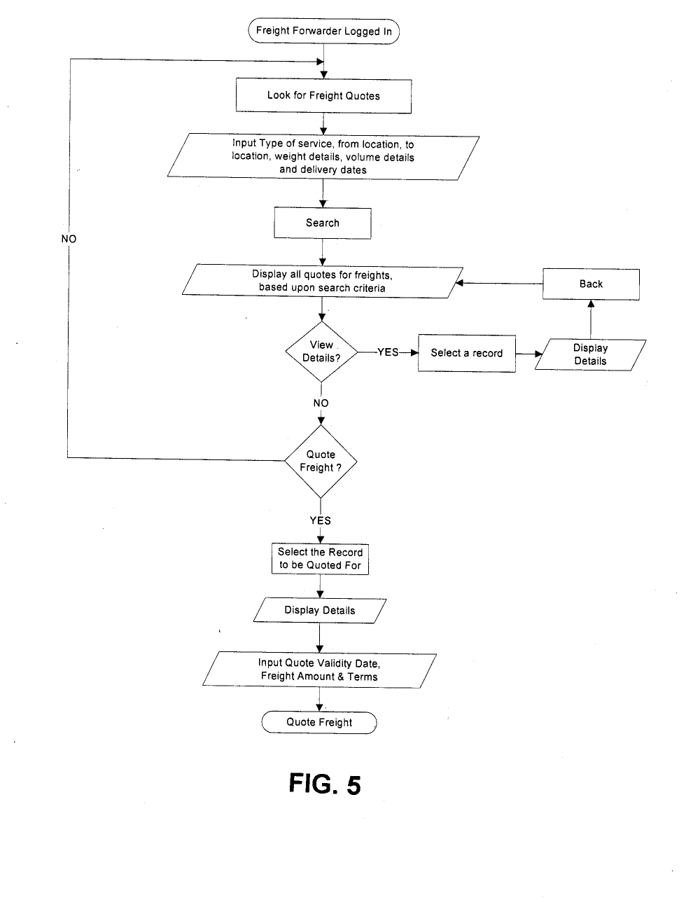

FIG. 6—Quote Approval by Shipper;

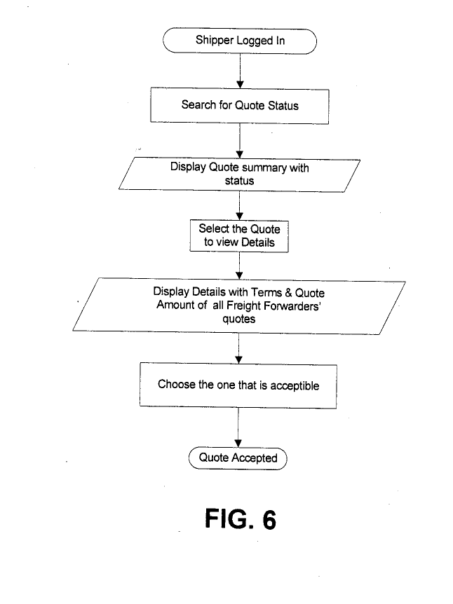

FIG. 7—Limit (Line of Credit) Request by Shipper;

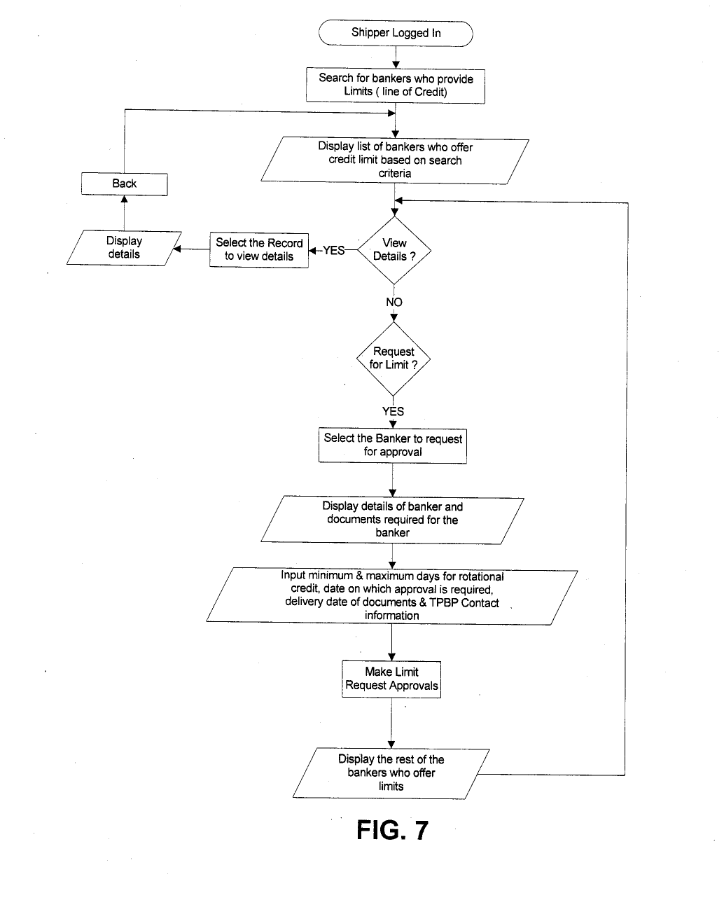

FIG. 8—Limit (Line of Credit) Approval by Banker;

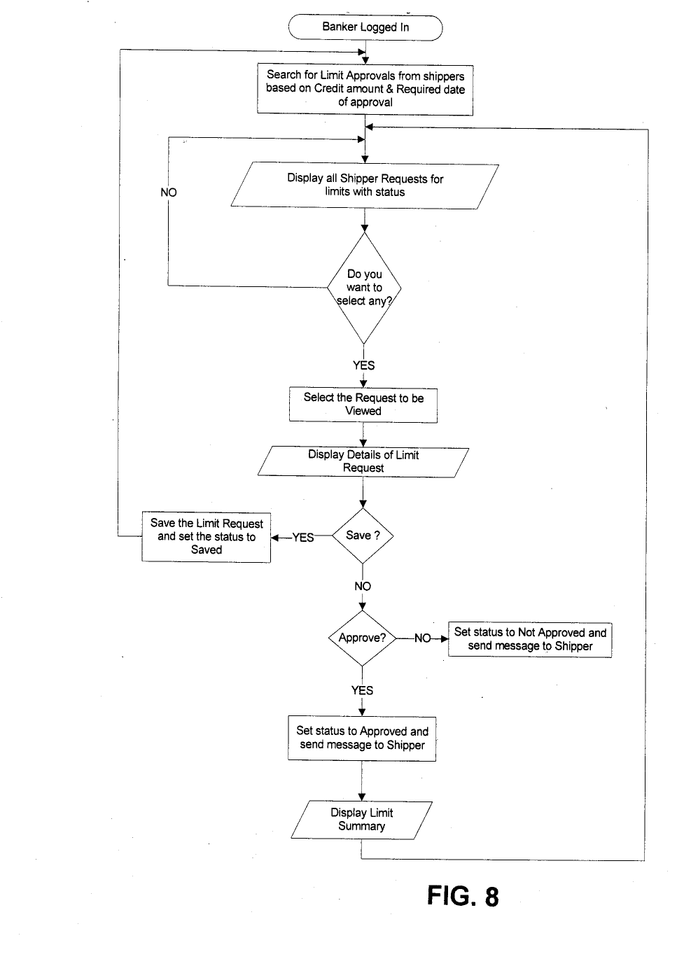

FIG. 9—Limit (Line of credit) Acceptance by Shipper;

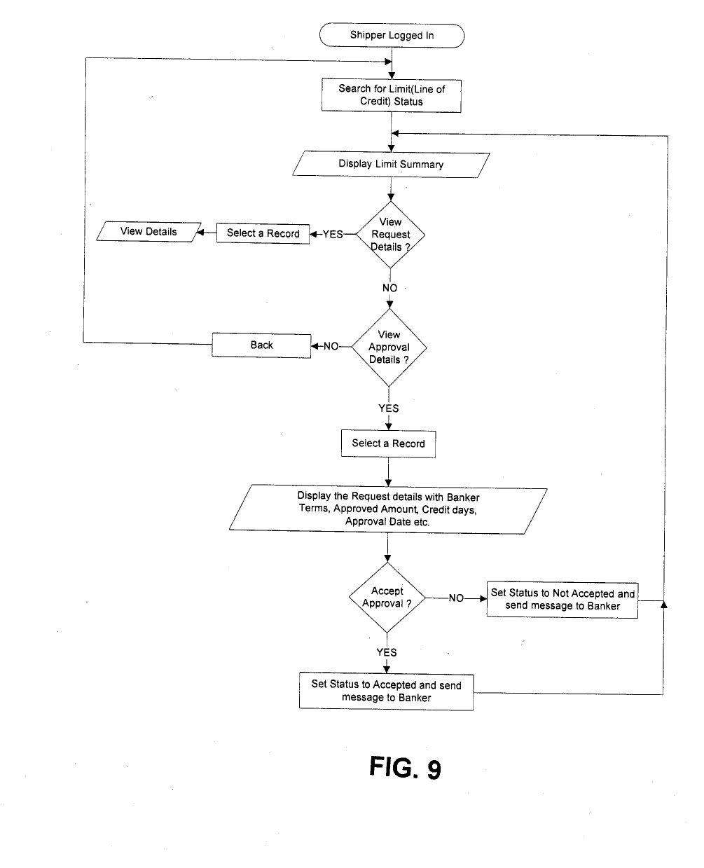

FIG. 10—TPBP (Third Party Bill Payment with variable interest rates and service charges) Request by Shipper. The process of bidding for TPBP by Banks is explained in this and following three Figures;

FIG. 11—TPBP (Third Party Bill Payment) Quote;

FIG. 12—TPBP (Third Party Bill Payment) Acceptance;

FIG. 13—TPBP (Third Party Bill Payment) Payment by Banker;

FIG. 14—TPBP Payment Receipt from Shipper (Customer) By Banker; and

FIG. 15—complete picture of the process.

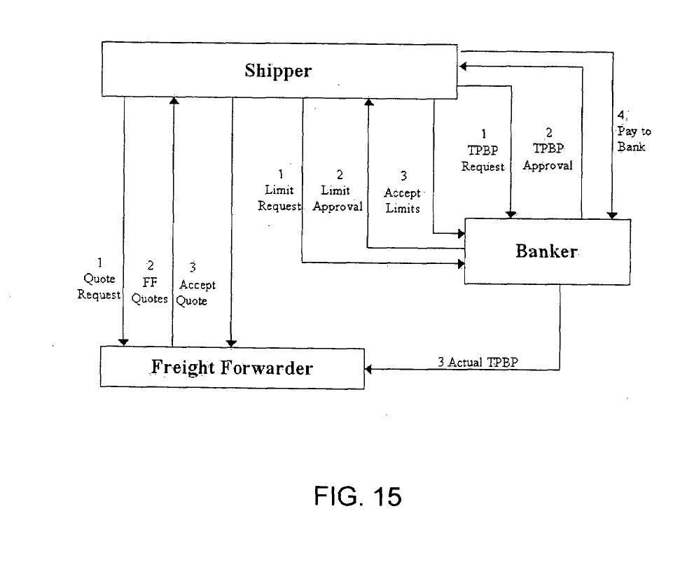

### DETAILED DESCRIPTION OF THE INVENTION

Embodiments of the present invention will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block figures and/or flowchart illustrations of methods, apparatus (systems) and/or computer program products according to embodiments of the invention. It is understood that several blocks of the block figures and/or flowchart illustrations, and combinations of blocks in the block figures and/or flowchart illustrations, can be implemented by computer program instructions. These computer program instructions may be given to a processor of a general purpose computer, special purpose computer, embedded computer, and/or other programmable data processing apparatus to produce a machine, such that the instructions, which execute via the processor of the computer and/or other programmable data processing apparatus, create means to perform the functions/acts specified in the block figures and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block figures and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block figures and/or flowchart block or blocks.

Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The Rules for the Bidding process used by the Company to establish the best rates as applicable be made available to the user, the Banking service present in the transaction is an advancement over the existing inventions/prior art is the advancement of the present invention.

The rules that are followed in the bidding process is as more specifically the following. The process of offering credit facility is explained below and it also mentions the criteria for offering credit facility:
i. When the Banker registers on Company's Web Portal he enters the Limit Range he wants to offer to the Customer
ii. Banker also customizes his approval form by entering what sort of documents/information he needs from the customer to approve the Limits.
iii. The Limit request process is explained in the FIG.-7. Limit (Line of Credit) Request by shipper.
iv. Limit Approval process is explained in the FIG.-8. Limit (Line of Credit) Approval by Banker.
v. Even if the Bank approves the limit it is left to the Customer to accept it or reject it—this is explained in the FIG.-9. Limit (Line of Credit) Acceptance by Shipper.

In the process of Shipper requesting for the Limit (credit lines) approvals from the Banker—The banker goes through the information provided by the shipper (customer) and will decide on the information provided whether he wants to extend him a line of credit or not. Here when he offers him line of credit (Limit) he will offer it without specifying the interest rate and the service charges. This will be decided on bill to bill basis when Customer puts the bill for bidding.

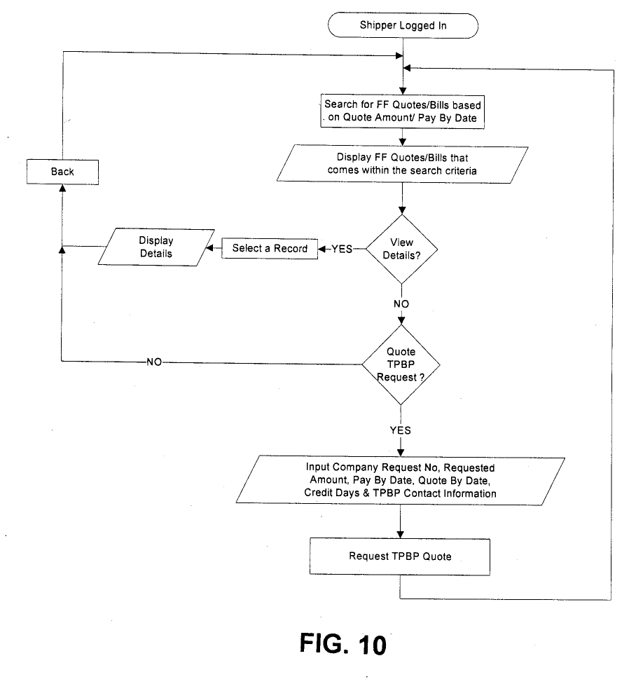

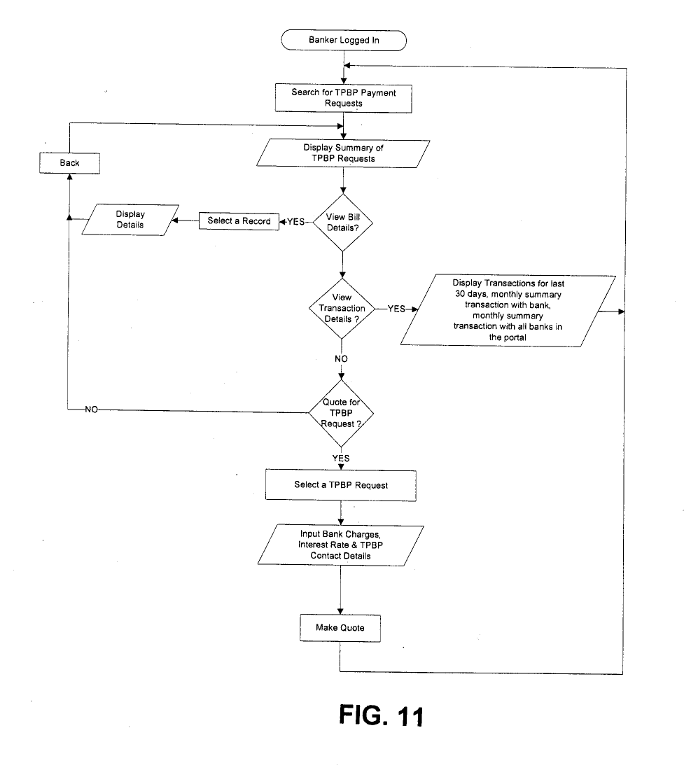

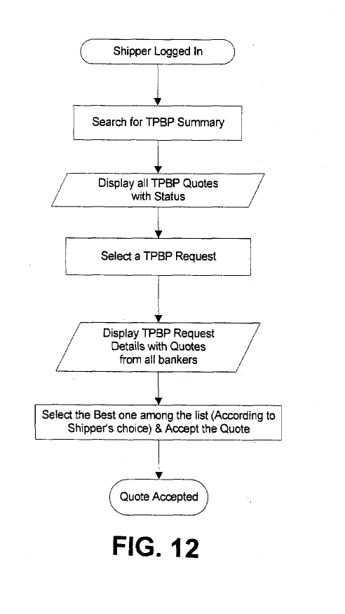

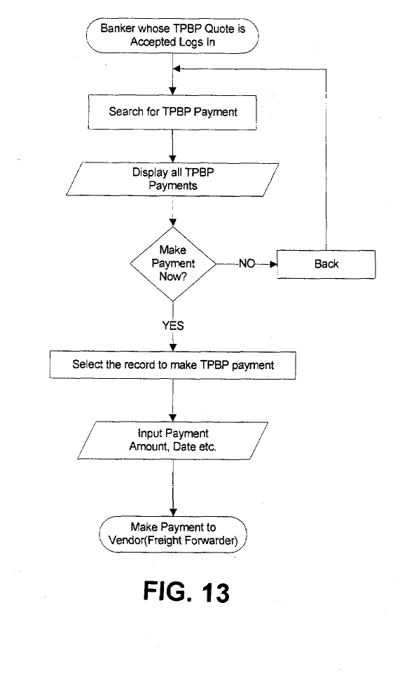

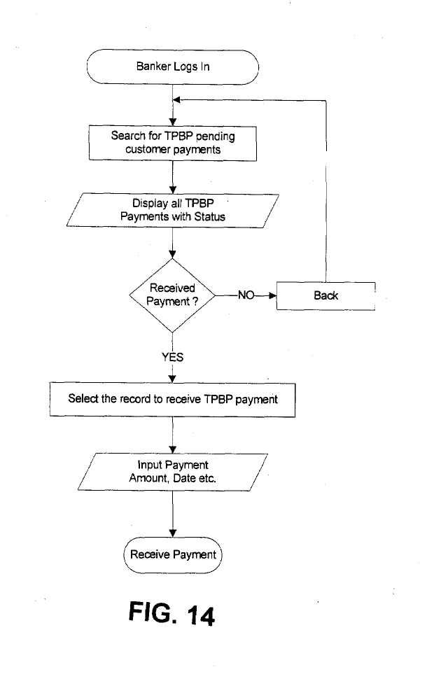

The process of bidding on the service charges and interest rates. The process of bidding for Third Party Bill Payment by Banks is explained in FIGS. 10 thru 14. Third Party Bill Payment with variable service charges and request by shipper is explained in FIG. 10. Third Party Bill Payment Quote is explained in FIG. 11. Third Party Bill Payment Acceptance is explained in FIG. 12. Third Party Bill Payment by Banker in FIG. 13. Third Party Bill Payment Receipt from Shipper (Customer) by Banker in FIG. 14.

The point of Manual entry on a logical decision is where the Banking customer decides which bank needs to pay his bill to the vendor. Bankers will quote their service charges and Interest Rates and it is left to the Shipper (Customer) who he wants to choose to make the Payment to the Vendor (in the illustrated case it is the Freight Forwarder.

What is claimed is:

1. A method to determine the best use of online web based business environment for
a. The User to make a nil investment to open an account with the Company's web portal.
b. The banker to disbursement of funds, issue new products and to maximize margins on transactions, thus obtaining high returns by bidding on the business and issue “credit limit” to user.
c. The Shipper gets the option to have multiples quotes for best rates from Freight forwarding agent, as well as obtain an optimum quote for “Credit limit” from multiple banks towards Third Party Bill Payment.
d. Freight forwarding agent to obtain maximum utilization of perishable space in a global environment on a low operational cost.

2. A method, according to claim 1, where the Shipper/Freight Agent/Banker are inter related in the transaction process, non competitive in nature of business.

3. The method of claim 1, further comprising the step of assigning the Credit Limit to the User an optimized credit limit if the applicant satisfies a set of business rules.

4. The method of claim 1, wherein the user receiving credit limits from multiple bankers, establishing a maximum exposure to optimized credit limit for the segment extended by various Bankers into which the user is placed, and selectively (manually) submitting the optimized credit limit from the Bank of User's choice to the business transaction.

5. A method of claim 1, which a user can compare and accept a Freight forwarding rate from a service provider and use the data from the Banker in connection with the Line of Credit applicable to the user, thus effectively obtaining choice in rates applicable from both service providers.

6. A method of claim 1, An advanced bidding process over prevalent Banking methods for Business to Business environment, that is existent in Shipping, Freight forwarding and Banking methods.

7. A method of claim 1, Providing for a facility of Variable Rates for Third Party Bill Payment over the Internet is an advancement over any of the prevailing Banking methods.
